(19) United States
(12) Patent Application Publication
(10) Pub. No.: US 2020/0338630 A1
(43) Pub. Date: Oct. 29, 2020

(54) METHOD FOR PRODUCING A CERAMIC CORE FOR THE PRODUCTION OF A CASTING HAVING HOLLOW STRUCTURES AND CERAMIC CORE

(71) Applicant: FLC Flowcastings GmbH, Trebur (DE)

(72) Inventor: Wolfram Beele, Nierstein (DE)

(21) Appl. No.: 16/962,632

(22) PCT Filed: Jan. 17, 2019
(86) PCT No.: PCT/EP2019/051169

§ 371 Date: Jul. 16, 2020

(30) Foreign Application Priority Data
Jan. 17, 2018 (DE) 10 2018 200 705.5

(51) Int. Cl. B22C 9/10; B22C 9/18; B33Y 80/00

(52) U.S. Cl. CPC B22C 9/103; B33Y 80/00; B22C 9/18; B22C 9/108

(57) ABSTRACT

The invention relates to a method for producing a ceramic core (4, 4′)—and to a core produced by this method—for preparing the production of a casting having hollow structures which the ceramic core is configured to form, making use of a 3D model of digital geometric co-ordinates of the casting, wherein the method comprises the following steps: a) Producing by means of casting technology at least one first portion (4) of the ceramic core including at least one first joining structure (24) in a surface of the portion; b) Producing by means of casting technology or 3D printing technology at least one second portion (4′) of the ceramic core including at least one second joining structure (26) matching the first joining structure, in a surface of the portion, wherein the production by means of casting technology comprises the following steps: i. Unpressurized or low-pressure casting of a ceramic core blank, and specifically with an oversize relative to the core (4, 4′) according to the geometric co-ordinates; ii. CNC processing of the core (4, 4′), according to the 3D model, in a first CNC processing method; c) joining the at least one first and at least one second portion of the core at the matching joining structures to form the core according to geometric co-ordinates of the casting.

This invention relates to improving a method in the field of precision casting for producing a ceramic core for preparing the production, by means of a ceramic mould, of a casting having hollow structures which the ceramic core is configured to form, thereby making use of a 3D model of digital geometric co-ordinates of the casting, and to improving a ceramic core of this kind.

The invention improves the production of all types of high-quality castings since it makes it possible, in a manner far less restricted than previously with respect to the complexity and geometric accuracy thereof, to form a lost model in a lost mould with lost cores not only without having to use moulds for producing the cores which directly reproduce the geometry of the cores, as is typically the case by means of ceramic injection moulding (CIM). It furthermore makes this possible even in the case of far larger casting and in particular core dimensions, and/or smaller and more complex details, in particular of the hollow structures and of the core thereof, the latter such as undercuts, than has been possible hitherto.

It is known that precision casting takes place with the use of a lost model in a lost mould, which is formed in the form of a single-use ceramic coating of the model. The known method comprises the following steps:
1. Production of a positive model (in the same form as the casting which is to be produced) from a hard or elastic material;
2. Production of a temporary mould by pouring a fluid over the model and cooling until it solidifies;
3. Extracting the model;
4. Forming a temporary model by pouring a second fluid into the cavity of the temporary mould and cooling until it solidifies;
5. Melting or dissolving the temporary mould;
6. Ceramic coating of the temporary model in order to form a solid ceramic shell around the temporary model;
7. Melting or dissolving the temporary model and evacuating the fluid thereby incurred from the ceramic shell;
8. Filling the cavity of the shell with molten metal and allowing this to solidify in order thereby to form the final casting.

Specifically, precision casting of hollow metal parts is a lost-mould method, and is also referred to as the lost-wax casting process. The manufacturing process then takes place in a typical industrial manner with the following steps:
1. A core made of ceramic material is obtained by ceramic injection moulding (CIM) into a multi-part reusable injection mould, and by subsequent releasing, burning, and finishing. The core forms, in a complementary format (as a negative), the geometry of the cavity in the later casting.
2. A wax model is produced around the core by wax injection moulding into a multi-part reusable injection mould. The core is in this situation laid into the wax injection mould. The wax model forms the outer contour of the metal part which is to be cast.
3. The wax model, together with the core, or a plurality of such wax models, are supplemented to form a structure (a wax cluster), a complete casting cluster, specifically with feeders (sprues) and casting gates, as well as filters, and, in the case of DS and SX casting, for example, with starters, nucleus selectors, and nucleus conductors.
4. A ceramic shell is formed on the wax cluster by immersing in a ceramic suspension (slips) and subsequent sanding and drying. Immersing, sanding and drying are repeated several times until the required shell thickness has been attained.
5. The wax model is melted out of the shell, typically in a steam autoclave under high pressure.
6. The shell is burned at temperatures of between 700° C. and 1100° C. As a result, residues of wax and other organic substances are burned out, and the ceramic shell material attains the strength required. By inspection and adjustment as necessary it is ensured that the shell is free of any damage.
7. Molten metal is poured into the shell. The metal then solidifies and further cooling takes place.
8. The shell is removed from the castings, specifically by chemical leaching and mechanical processing. The components are separated from the gating system.
9. The core is removed from the cavity of the metal casting by chemical leaching in a pressure autoclave.
10. All residues of superfluous metal are removed from the component.

Most manufacturers of gas turbines work with improved multi-walled and thin-walled gas turbine blades made of superalloys. These comprise complicated air cooling channels in order to improve the efficiency of the internal cooling of the blades, such as to allow for greater thrust and achieve a satisfactory service life. The US patents 5.295.530 and 5.545.003 relate to improved multi-walled and thin-walled gas turbine blade designs, which for this purpose comprise complicated air cooling channels.

Precision casting is one of the oldest known original moulding processes, which was first used thousands of years ago in order to produce detailed works of art from metals such as copper, bronze, and gold. Industrial precision casting became commonplace in the 1940s, when the Second World War increased the demand for dimensionally-precise components made from specialised metal alloys. Nowadays precision casting is frequently used in aviation and energy plant construction in order to manufacture gas turbine components such as blades and fins, with complex shapes and internal cooling channel geometries.

The production of a gas turbine rotor blade or guide blade from a precision casting usually involves the production of a ceramic casting mould, with an outer ceramic shell having an inner surface which corresponds to the shape of the blade, and with one or more ceramic cores positioned inside the outer ceramic shell, corresponding to the internal cooling channels which are to be formed inside the carrying surface. Molten alloy is poured into the ceramic casting mould, then cools and hardens. The outer ceramic shell and the ceramic core(s) are then removed by mechanical or chemical means in order to release the cast blade sheet with the external profile shape and the cavities of the internal cooling channels (in the form of the ceramic core(s)).

There are a large number of techniques for the forming of mould inserts and cores, with geometries and dimensions which are of very considerable complexity and rich in detail. An equally varied array of techniques are used in order to position the inserts in the mould and keep them in place. A widespread technique for holding cores in mould arrangements is the positioning of small ceramic pins, which can be formed as one piece with the mould or the core or both, and which project from the surface of the mould to the surface of the core and serve to position the core insert and support it. After the casting process, the holes in the casting are filled, for example by welding or a similar method, preferably with the alloy from which the casting has been formed. The cores can also be held by core locks and core marks, which are part of the respective core. If necessary, additional ceramic pins can be attached for stabilisation. The holes of additional ceramic supports can be welded closed. Holes that are required for functional purposes (for example for cooling) can be left open.

A further possibility for additional support (in the case of castings made of nickel-based alloys) are pins made of platinum wire which emerge from the shell and rest on the core surface. These become part of the casting structure, and only the length of the platinum pins protruding above the metal surface is removed during finishing.

The ceramic core is typically brought into the desired core shape by injection moulding (Ceramic Injection Moulding—CIM) or transfer moulding of ceramic core material. The plastic injection compound for the ceramic core material comprises one or more ceramic powder components, a plastic binding agent, and optional additives, which are injection moulded into a correspondingly shaped core mould.

A ceramic core is usually produced by means of injection moulding in that, first, the desired core shape is formed in corresponding casting mould halves of the core, made of hardened wear-resistant steel, by precision machining, and the mould halves are then brought together to form an injection volume which corresponds to the desired core shape, whereupon the injection of ceramic moulding compound into the injection volume takes place under pressure.

The moulding compound contains, as already described, a mixture of ceramic powder and binding agent. After the ceramic moulding compound has hardened to a “preform”, the mould is opened in order to release the preform.

After the preform mould core has been removed from the mould, it is debound and burned at high temperature in one or more steps in order to remove the volatile binding agent and to achieve the desired density and strength of the core, and specifically for use in the casting of metallic material, such as a nickel- or cobalt-based superalloy. These are normally used to cast single-crystal gas turbine blades.

When casting the hollow gas turbine blades with inner cooling channels, the burned ceramic core is positioned into a ceramic precision casting shell mould in order to form the internal cooling channels in the casting. The burned ceramic core in the precision casting of hollow blades typically has a flow-optimised contour with an inflow edge and an outflow edge of thin cross-section. Between these front and rear edge regions the core can comprise longitudinal openings, although they may also be of other shapes, in order to thereby form inner walls, steps, deflections, ribs, and similar profiles for delimiting and producing the cooling channels in the cast turbine blade.

When producing the outer mould shell, the burned ceramic core is then used in the known lost-wax casting method, wherein the ceramic core is arranged in a model casting mould, and a lost model is formed around the core, specifically by injection under pressure of model material such as wax, thermoplastic material or the like into the mould in the space between the core and the inner walls of the mould.

The complete casting mould made of ceramics is formed by positioning the ceramic core inside the assembled mould made of precision-machined hardened steel (referred to as the wax model mould or wax model tool), which defines an injection volume which corresponds to the desired shape of the blade, in order then to inject molten wax into the wax model mould around the ceramic core. When the wax has solidified, the wax model mould is opened and removed, and yields up the ceramic core surrounded by a wax model which now corresponds to the shape of the blade.

The temporary model, with the ceramic core in it, is then repeatedly subjected to steps for building up the shell mould thereon.

For example, the model/core module is repeatedly immersed in ceramic slip, with superfluous slip being allowed to drain off, sanded with ceramic pieces, and then air-dried, in order to build up several ceramic layers, which form the mould shell on the arrangement. The resulting enveloped model/core arrangement is then subjected to the step of removing the model, for example by means of a steam autoclave, in order to specifically remove the temporary or lost model such that the mould shell, with the ceramic core arranged inside it, remains. The mould shell is then burned at high temperature in order to produce an appropriate strength of the mould shell for the metal casting.

Molten metallic material, such as a nickel- or cobalt-based superalloy, is poured into the pre-heated shell mould and allowed to harden in order to produce a casting with a polycrystalline or monocrystalline grain. The resulting cast blade sheet still contains the ceramic core in order, after removal of the core, to form the internal cooling channels. The core can be removed by leaching in a hot concentrated alkaline solution, or by other conventional techniques. The hollow cast metallic flow-profile casting component then comes into being.

This known precision casting method is expensive and time-consuming. The development of a new blade design is typically associated with many months and hundreds of thousands of Dollars of investments. In addition, design decisions are limited by procedural restrictions during the production of ceramic cores, due, for example, to their fragility as well as due to the time-consuming production of cores rich in detail or of large size. The metal processing industry has indeed recognised these limits, and has at least developed a number of gradual improvements, such as, for example, the improved method for casting cooling channels on a blade outflow edge in U.S. Pat. No. 7,438,527. However, because the market is constantly demanding greater efficiency and higher performance from gas turbines, the limits of existing precision casting processes are becoming ever more problematic.

Precision casting techniques are prone to a range of imprecisions. While imprecisions on the outer contour can often be corrected with conventional machining techniques, those involving internal structural shapes of cores are difficult, and often even impossible, to eliminate.

Internal imprecisions derive from known factors. These are, as a rule, imprecisions during the production of the core structure, imprecisions during injection around the core in the wax mould during manufacture, assembly of the mould, unexpected changes or defects due to fatigue of the ceramic moulds, and failures of the shell, the core or the securing elements during the manufacture, assembly, and handling before or during the casting process.

The precise design concept, dimensioning, and positioning of the core insert has become the most difficult problem in the production of moulds. These aspects of precision casting form the basis of the invention, although the method of this present invention can also be used in other technologies.

Typically, the production of the casting mould and core is restricted in the possibilities of reliably forming fine details with adequate resolution. With regard to the precision of positioning, reliable dimensions, and the production of complex and richly details moulds, the known systems are very limited.

The core inserts are, as a rule, shaped or moulded parts which are produced with the use of conventional injection or moulding of ceramics, followed by suitable burning techniques. It is in the nature of these ceramic cores that the precision is substantially less than can be achieved, for example, in metal casting processes. There is far greater shrinkage in the conventional ceramic casting compositions, or there are faults such as a substantial inclination to crack formation, blisters, and other defects. There is accordingly a high defect and rejection rate, deriving from imperfections which cannot be corrected and which are caused in turn by defective cores and incorrect core positioning. In any event, at least a high degree of effort and expenditure is required during reworking to correct the casting components which lie outside the tolerances, if they are actually able to be corrected at all by way of subsequent machining, grinding, and the like. The productivity and efficiency of the precision casting process is substantially limited by these restrictions.

A further limiting aspect of precision casting has always been the considerable lead time for the development of moulds and mould tools, usually of metal, for the cores and the temporary model, as well as the high degree of effort and expenditure associated with this. The development of the individual phases of the mould and mould tools, including, in particular the geometry and dimensions of the wax moulds, the geometry and dimensions of the preform, and the final geometry of the burned moulds, in particular of the cores, and the resulting configuration and dimensioning of the casting produced in these moulds, are dependent on a large number of variables, including warpage, shrinkage, and crack formation during the different production steps, and in particular during the burning of the ceramic preforms. As the person skilled in the art in this field is well aware, these parameters cannot be precisely foreseen, and the development of precision casting moulds is a highly iterative and empirical process of trial and error, which for complex castings typically extends over a period of 20 to 50 weeks before the process can be taken into operation.

It follows from this that complex precision casting of hollow bodies, in particular for the production of individual parts, is restricted, and casting in substantial unit numbers is, as a rule, not possible due to the limited cycle numbers of the process and its elements, in particular of the moulds and mould tools. Changes in the design of the castings require subsequent machining and processing of the moulds and tools on a corresponding scale, and are therefore very expensive and time-consuming.

The prior art has devoted attention to these problems, and has made progress in the use of improved ceramic compositions, which to a certain degree reduce the occurrence of such problems.

Although these techniques have led to improvements, they have been at the expense of the costs of the casting process, and nevertheless still do not achieve all the improvements required.

With regard to those techniques which involve an effect on the preforms, and in particular mechanical processing of the preforms, experience has shown that the changes in the dimensions during the burning of the ceramic bodies still continually cause a series of imprecisions which restrict the attainment of the geometry and dimensions of the burned bodies which are being striven for. Due to the fragility of the preforms, the techniques which can be used are in themselves limited, and, as a rule, a substantial amount of manual work is required. Even with the best precautionary measures and the greatest care, a substantial proportion of the cores are ultimately destroyed by the work processes.

However, particularly disadvantageously, the efforts of the prior art, even the most recent, have achieved little towards improving the cycle time of the development of moulds and mould tools, or reducing the number of repeated operations required, which are necessary for producing the final moulds and mould tools with the required precision of shape and dimensions. The prior art has not provided any effective techniques for reworking the shapes of shells and cores which are outside the specifications, or for changing the moulds to meet design changes, without restarting the mould and mould tool development process.

As already indicated, casting cores are conventionally produced in accordance with the CIM method (Ceramic Injection Moulding). A ceramic “feedstock”, which is plasticised by means of the admixing of wax and other additives, is injected under pressure into an injection moulding mould. The complete geometry of the core is formed by the injection moulding mould. After demoulding, the core is debound and burned at a specific temperature curve (burning temperature typically between 1000° C. and 1300° C.).

Finishing of the cores, for example for the removal of ridges or for other corrective measures, as may be required, can be carried out, as is known, in different ways:
Finishing is typically carried out manually, with diamond grinding tools.
CNC-supported finishing with diamond grinding tools is likewise known. In this situation, the cores are fixed in a device by mechanical clamping.
Also known is a partial realisation of specific geometric details of casting cores by CNC milling. In this situation, casting cores are prepared in accordance with the CIM process, wherein specific geometric details in the form of machining allowances are included in order to allow for subsequent completion by CNC milling.

This has the following disadvantages: With traditional core production by CIM, the moulding of cores takes place in the end contour as a preform. A subsequent debinding and burning process is necessary in order to achieve the desired properties of the core material. In this situation, the cores experience deformation due to shrinkage effects caused by the release of internal stresses and possible loading under the dead weight of the moulding. A typical effect which in this situation leads to dimensional deviations and the rejection of casting cores is warping (torsion) of the geometry.

In addition, core production by CIM (Ceramic Injection Moulding) requires the use of highly-complex injection moulding moulds and tools. The high complexity of these moulds and tools corresponds to the complicated cooling circuit arrangements (for example with serpentines, turbulators, outlet channels, . . . ) in the interiors of high-pressure turbine blades. The production of these moulds and tools is associated with high costs (not unusually several hundreds of thousands of Euros) and long lead times (usually of several months) until a mould or tool is available for a new component geometry. Casting plant products (rotating and static high-pressure turbine blades) for the construction, for example, of gas turbines are consequently only available after a period of typically one to two years.

Repeated adjustments of the component geometry often lead, in the structural design process, to a necessary change to the mould or tool, which in turn requires a correspondingly long time. A shortening of the repeated geometry adjustments can, in particular, contribute to shortening the development cycles of gas turbines, and manufacturers of gas turbines are therefore able to react more rapidly to the changing requirements of the market.

In WO2015/051916A1 a method is described for the precision casting of hollow components. In this method, a casting core is produced from a blank of ceramic material by subtractive means using CNC processing. The ceramic blank material is already in a burned state, and, after the production of the end contour by CNC processing, requires no further burning. Following this, the core is embedded in model wax, and the wax model outer contour is produced in turn by CNC processing. The congruent positioning of the co-ordinate systems of core and wax model, within tolerances of +/−0.05 mm or better, is ensured by the special mechanical structure of the CNC processing device.

The advantages of this technology consisted, among others, of the fact that, for the production of wax models with ceramic cores which are suitable for precision casting, no highly complex and highly precise injection moulding moulds and tools that directly reproduce the component geometry were required any longer, which consequently means that the associated costs and lead times could be avoided. The CIM-produced core blank could be provided with larger contours since more complex geometries could be produced precisely in the later CNC step. Additionally, due to the direct CNC processing of the core into the end contour, dimensional distortions and rejections were already avoided, such as occurred in the conventional previous (and also still present day) production of the core by CIM. The blank, however, according to this improved technology of the prior art was, as indicated, also produced, as usual, by means of CIM.

One object of the present invention is to provide a method for producing precision casting moulds with mould cores, as well as the mould cores themselves, with improved reproducibility, dimensional accuracy, precision, and speed of production.

This object is solved by a method with the features of claim 1 and a core with the features of claim 2. Preferred embodiments are presented in the sub-claims.

The invention relates to a method for the production of casting cores in particular with complex geometries for use in the precision casting of hollow metal components (according to a 3D model of digital geometric co-ordinates of the respective casting). Casting cores are used in order to reproduce the geometry of the cavities in the interior of the component, such as, for example, cooling circuits with complex geometries.

The production (preferably without casting tools) of the casting cores according to the invention preferably in particular does not require any injection moulds and moulding tools. The shaping takes place in particular by means of CNC milling from blanks made from suitable ceramic material which are in particular not close to the final shape—particularly preferably in combination with core portions which are produced by means of 3D printing—and/or in combination with core portions which are likewise produced by means of casting (the latter in particular in order to make it possible to produce in particular cores having overall dimensions which hitherto could not be produced in this size).

Thus, within the meaning according to the invention, “production by means of casting technology” means in particular also the shaping of a ceramic semi-finished product of the core that contains any casting step (only for example ceramic slip casting or ceramic injection moulding, CIM)—in particular (but not necessarily) with an oversize, in particular over the entire surface of the end contour (according to the geometric co-ordinates—i.e. in particular the entire surface of the end contour, which is part of the surface of the core's shape during the final casting—which thus does not necessarily include, for example, flange surfaces or positioning reference surfaces), and thus in particular also without partial (and therefore possibly entirely without any) reproduction of the end contour (which consequently in turn means that the oversize can also be without reproduction of the end contour, i.e. can be an oversize that follows only the criterion of being in some way larger than the exact target dimension of the core (according to the geometry data also of the core), i.e. possibly also without any other criterion for the oversize, such as an oversize of a particular size or particular minimum size or particular size having a particular tolerance—and thus that the outer contour of the semi-finished product follows only the criterion of being, as a whole, outside of the contour of the target dimension of the core)—with subsequent CNC processing, i.e. for example CNC milling. In this embodiment the cast ceramic part is, for example, not yet usable as a core matched to the final contour, but merely as a semi-finished product therefor.

Within the meaning according to the invention “production by means of 3D printing technology” can, for example, also be referred to as generative or additive production of a ceramic moulded body.

The blanks in the part of the production method according to the invention involving casting technology are produced, for example, by slip casting of aqueous ceramic suspensions, and subsequent burning of the ceramic moulded bodies. The CIM (Ceramic Injection Moulding) method that is usually used in traditional casting techniques for manufacturing cores is preferably not used. In comparison with the traditional method, this method provides significant advantages with regard to the lead time with which, for example, first casting cores with altered geometries can be produced, as well as with regard to the dimension tolerances of the casting cores produced.

The invention therefore relates to a method for producing a ceramic core for preparing—and to such a ceramic core for—the production of a casting having hollow structures which the ceramic core is configured to form, using a 3D model of digital geometrical co-ordinates of the casting, wherein, in a preferred embodiment, the method comprises the following steps:
1. Defining, in the 3D model, at least one interface or join location or patch, up to which the core geometry details are to be produced by casting technology as a one-piece core component region or core base body, in particular by means of a core blank with an oversize and the subsequent CNC processing thereof. In this way, the overall core can be assembled at the joining points, in accordance with the invention, from at least two core component regions. They can all be produced by means of casting technology, the production by means of casting technology comprising the following steps:
   i. Unpressurised or low-pressure casting of a ceramic core blank, and specifically with an oversize relative to the core (4, 4′) according to the geometric co-ordinates;
   ii. CNC processing of the core (4, 4′), according to the 3D model, in a first CNC processing method,
for example in order to be able to exceed dimension limits, for instance of the producibility of an overall core formed as one piece. Alternatively at least one core component region on the other side of the joining point can be produced by means of 3D printing technology, in particular in order to be able to produce smaller and more complex details there, such as undercuts for example, than can be achieved by means of casting techniques.
2. Designing a first (and (see 4. below) a matching second) joining structure of the at least one interface or joining location in order to establish a connection to a further core component region.
3. Optionally: Defining in the 3D model the core component regions which are produced as ceramic by means of 3D printing technology. The definition follows the preferred rule of implementing particularly finely detailed features or particularly small and complex details in 3D printing technology, for example in order to achieve greater design freedom with respect to gap widths, undercuts and the like (which are problematic in CNC milling for example).
4. Designing the mating body for the joining structure denoted in b), i.e. designing a second joining structure, matching the first, of the at least one interface or join location or patch, to which the second, in particular 3D-printed, core component region is joined to the CNC processed core base body.
5. (In particular unpressurised or low-pressure) casting of a ceramic core blank, and specifically with an oversize relative to the core according to the geometric co-ordinates.
6. Positioning the core blank in a processing holding device.
7. CNC processing of the core according to the 3D model in a first CNC processing method.

The method and the core are preferably characterised in that the casting production method part in step 1. is achieved by means of slip casting, pressure slip casting, cold isostatic pressing, hot isostatic pressing, uniaxial pressing, hot casting, low-pressure injection moulding, gel casting or extrusion, and/or in that the CNC processing in step 1. is CNC milling.

The further method preferably comprises the following steps:
8. 3D printing of at least one core component region by means of ceramic printing technology. Aluminium oxides can be printed, but it is preferably possible for a silicate ceramic, for example, to be used, specifically preferably a ceramic material based on silicate ceramic, for example fused silica (SiO₂), possibly with the addition of other oxides. The 3D printing method can be performed for example stereolithographically (SLA), in a laser-selective manner (selective laser sintering, SLS), by means of powder bed printing (binder jetting), or alternatively also in accordance with a sintering principle from a plastic mass by means of ceramic injection moulding (CIM).
9. Preparing the two joining surfaces or joining structures, for example as a clearance fit, with or without a ceramic adhesive.
10. Joining the two core component regions, for example: by means of suitable positioning retaining devices for both parts; by means of a form-fitting connection according to the tongue-and-groove principle; by means of a cylindrical or oval pin (also stellate, spherical, oval or a combination, in a symmetrical or asymmetrical design), in particular also by means of a form-fitting connection to the core base body. The form-fitting connection is preferably achieved as a clearance fit, with a tight clearance fit being particularly preferred in the case of purely a form-fitting connection, and a wide clearance fit being particularly preferred in the case of a ceramic adhesive being used.
11. As an alternative to direct further processing, heat treatment may be carried out in order to connect the two ceramic parts (and optionally the adhesive).
12. Maintaining the positioning (or re-positioning) of the core in a processing holding device.
13. Pouring of model material around the core into a volume greater than (i.e. in particular possibly also with an oversize, in the meaning set out above, with respect to the geometric data of the casting) the cubic dimensions of the casting, which, according to the 3D model, is spatially determined by the position of the core in the processing holding device, and allowing the model material to solidify.
14. CNC production of an outer contour of a lost model of the casting from the solidified model material around the core, in accordance with the 3D model in a second CNC production method.
15. Applying a ceramic mould onto the outer contour of the lost model and formation of a positioning connection of the ceramic mould with the core.
16. Removing the lost model from the ceramic mould around the core.
17. The form-fitting connection of the core parts can be set to the desired final strength, for example directly by the burning cycle of the outer contour mass, or by a specifically modified heat treatment process.
18. Pouring metal into the ceramic mould around the core.
19. Solidifying of the molten metal to form the solid casting, and
20. Removing the ceramic mould and the core from the casting.

In this case, the casting core geometry is realised according to the following criteria:

According to the invention, a core base body is preferably defined as such since this can absorb and bear the majority of the force applications during waxing, de-waxing and burning of the outer contour, but also during the metal casting and the metal solidification. It is therefore possible to targetedly use a ceramic in the CNC-formed core base body which has properties that correspond to the known CIM-produced core materials or which has even higher strengths at a reliable degree of releasability following casting.

Finely detailed core geometries, for example outlet edge channels or (at least) second core shells in the case of multi-walled cooling designs (“onion principle”), can then be produced by means of 3D printing technology, for example having joining surfaces, which allows for even finer details and geometrically more challenging elements, for example having undercuts.

The attainment of the casting core geometry and/or end contour can therefore, according to the invention, take place completely and exclusively by CNC processing. The production of the blank takes place preferably by the slip casting of aqueous ceramic suspensions, with subsequent drying and burning:

A ceramic core material, which is suitable for use with SX (Single Crystal), DS (Directional Solidification), or equiaxed vacuum precision casting, is produced from known raw materials. The properties of mechanical strength, resistance to high temperature, thermomechanical behaviour from room temperature to above 1550° C., such as dilatometry and creep resistance, porosity, and solubility in concentrated alkali, can be adjusted in a suitable manner such that the proportions and particle size distributions of the individual mineral components can be adjusted in a suitable manner. In particular, by way of the mineralogical composition in conjunction with the firing curve, the formation of cristobalite as a consequence of the crystallisation of the main component fused silica is restricted to a low level.

The geometry of the blanks does not need to be close to the end contour. Preferably, the blank has a processing allowance of 1 mm or more in particular in relation to all geometry-relevant places of the end contour.

Advantageously, the geometry of the blanks can be optimised for the best possible uniform and reproducible ceramic properties.

The feedstock for the shaping of the blanks can be a water-based ceramic suspension (“slips”, although other solvents are also possible). These are mixed from the individual raw material components of the ceramic core material, namely several ceramic raw materials which are usually in powder form, in particular fused silica as main component, as well as other oxides and organic additives.

The shaping of the blanks is preferably carried out not as in traditional casting core production by CIM, but by unpressurized or low-pressure casting in gypsum moulds. A further possibility, namely a low-pressure casting technique, is therefore, according to the invention, pressure slip casting, for example in moulds of a porous plastic with a pressure slip casting machine. Other possible methods are, for example, CIP (Cold Isostatic Pressing), hot casting, low-pressure injection moulding, gel casting, or dry pressing.

Preferably, therefore, the ceramic moulding bodies are then dried and burned in accordance with a defined temperature curve. Burning temperatures are typically between 1000° C. and 1300° C. The ceramic moulding bodies thereby obtain their properties of density, porosity, and mechanical strength in the required manner. Water and all organic additives are thereby removed. The moulding bodies obtained in this way exhibit, in comparison with the prior art, a perceptibly better and homogeneous structure, and have low internal stresses or are even free of them altogether. This freedom from shrinkage holes and cavities, and the favourable internal stress condition are ideal preconditions for successful CNC processing.

The properties of density, porosity, and mechanical strength of the burned blanks can be specifically modified by the appropriate additives in suitable concentration in the ceramic suspension (feedstock, slips). This allows the raw material to be adjusted in order to enable and optimise treatment by CNC processing and also in the following precision casting process.

Locally, too, the properties of density, porosity, and mechanical strength of the burned blanks can be adjusted specifically. This allows the raw material to also be adjusted locally in order to actually enable and optimise treatment by CNC processing and in the subsequent precision casting process. For the local adjustment of the properties of the burned blanks, among other procedures, treatment with organic or inorganic substances can be carried out, which penetrate into the pore intermediate spaces of the ceramic material, or form a surface layer. These substances modify the mechanical, thermomechanical, and chemical properties of the ceramics in a suitable manner. For the local adjustment of the properties of the ceramic blanks, however, it is also possible, for example, for ceramic fibres, glass fibres, synthetic fibres, natural fibres, ceramic fibre fabric, glass fibre fabric, synthetic fibre fabric, ceramic rods, glass rods or quartz rods to be embedded into the mould bodies. By means of the admixture of fibres, for example, it is also possible to adjust the properties of the ceramics not only locally but overall, i.e. “globally” distributed over the entire mould body, for instance by uniformly mixing glass fibres, for example, into the entire ceramic suspension before this is used for the slip casting process.

It is also possible, for the local adjustment of the properties of the ceramic blanks, for property gradients to be established which run through the ceramic mould body in a defined orientation which is favourable for the CNC processing.

With regard to the CNC processing in step b), the following possibilities and advantages are derived:

The fixing of the blank for the CNC processing is preferably put into effect by means of a device. The device can fix the blank at several points, or from several sides, or from one side, and thereby ensures adequate mechanical stability even at finely defined regions of the core geometry.

As an alternative, the fixing of the blank for the CNC processing does not take place mechanically by way of a releasable connection, by non-positive, positive, and/or frictional fit, but also by material joining by bonding by means of a suitable joining compound with the device.

Before or after partial performance of the processing steps for the complete core, the fixing of the blank for CNC processing can be temporarily supplemented by an embedding compound which can be removed again, which matches to the contour, or by temporary supports. For connecting the blank to the CNC device, a compound can be used which is specially intended for that purpose, which simultaneously bonds both to the ceramic core material as well as to the metal of the device (typically, for example, steel or aluminium). In addition, the compound should not be subject to attack by the operational media which may possibly be used during the CNC processing (such as compressed air, oils, water, corrosion protection agents). Suitable, for example, is “Nigrin 72111 Performance Full-Spachtel” (filler).

The processing is carried out by means of CNC milling, i.e. in particular by means of a milling tool with defined cutting geometry and/or by CNC grinding, in particular by means of a grinding tool with an abrasive fitting.

The CNC tools are preferably, in accordance with the processing of the abrasive core material with minimum possible tool wear, tools with cutter blades made of polycrystalline diamond (PCD) or cubic boron nitride (CBN). This is due to the fact that possible deviations from the dimension tolerances of the end contour as a consequence of wear-induced changes in the cutting geometry can thereby be avoided or kept to a low degree.

The use in the context of casting technology of a mould produced in accordance with the invention includes, for example, monocrystalline, DS, and equiaxed vacuum precision castings, only by way of example, of turbine components made of nickel-based alloys.

A significant advantageous property of the method according to the invention is the moulding being first carried out on ready burned core material. This means that a very high degree of dimensional accuracy of the finished cores can be achieved within tolerances in the range of <+/−0.1 mm of the end contour. The disadvantages described above in traditional core production by means of CIM, in relation to dimensional accuracy and yield, are thereby eliminated. The completely CNC-based realisation of the core end contour also makes it possible, on the basis of a newly-attained geometry, for first cores to be produced with very short lead times, which are suitable, without restrictions, for the production of commercially exploitable components by precision casting. Slight alterations to an existing component geometry can now be implemented by simply altering the CAM and CNC programs and without the need to alter the devices or the geometry of the blank. The reaction times for such slight alterations are therefore very short. Even more advantageously, the core product is provided with a perceptibly improved material homogeneity and/or additionally with locally adjusted special material properties. The possible type of fixing of the ceramic blank in the CNC device further allows for perceptibly improved quality and yield of the cores produced in accordance with the invention.

These and other advantages and features of the invention are further described on the basis of the following illustrations of an exemplary embodiment of the invention. In the figures:

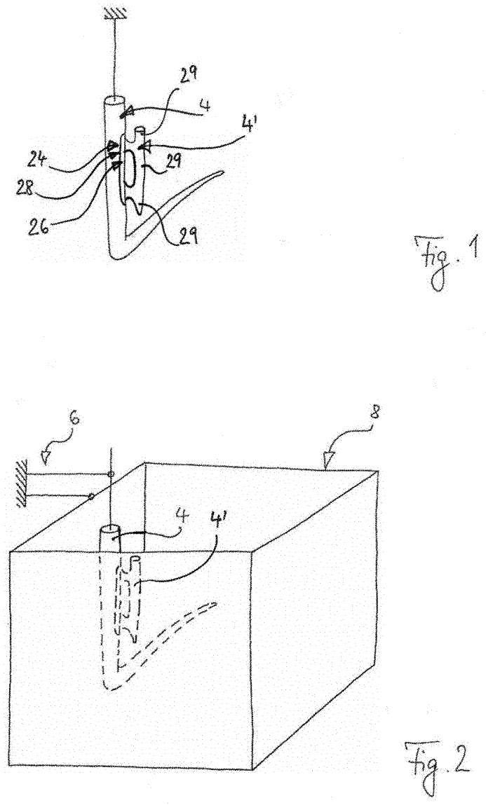

FIGS. 1 to 7 are schematic views of successive steps of a method according to the invention for producing a casting that comprises hollow structures.

FIG. 8a to c are schematic views of cores according to the invention, from the side (FIG. 8a), and in two alternative cross-sections,

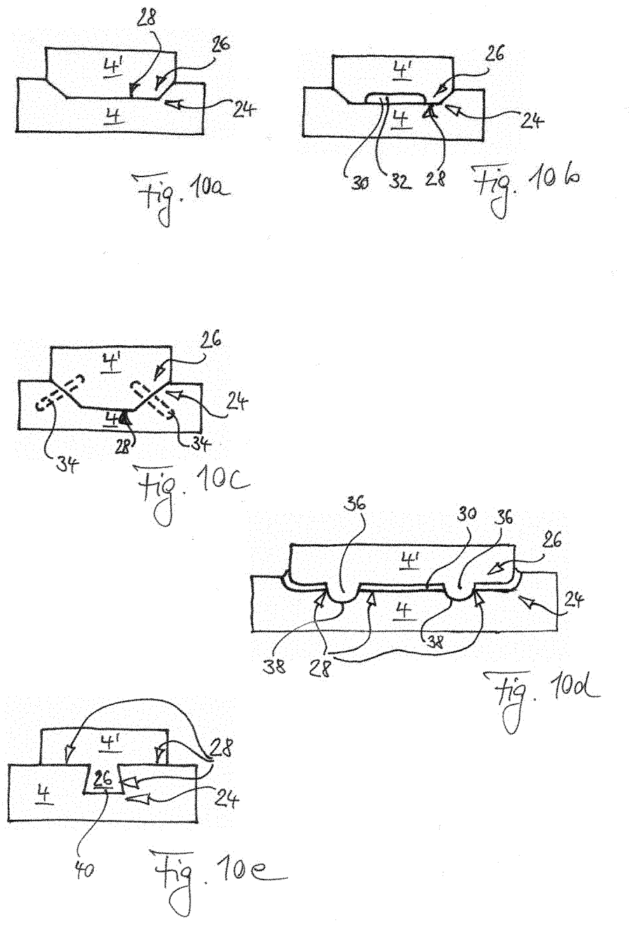

FIGS. 9a and b are schematic views of a core according to the invention, from the side (FIG. 9a), and in cross-section, and

FIG. 10a to e are schematic cross-sections of joining points of core component regions of cores according to the invention.

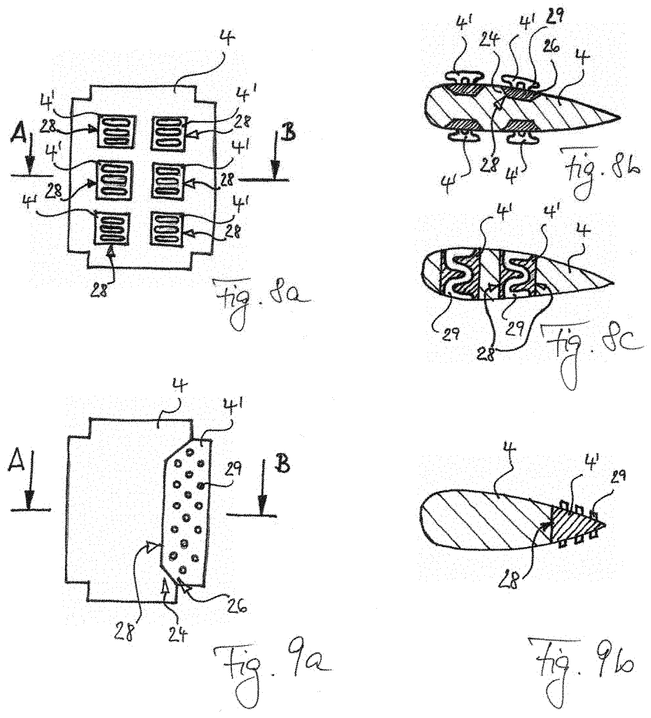

These (highly schematic) figures illustrate the production of a casting 2 (FIG. 7) comprising hollow structures 3, 3′ (using a 3D model, specifically a three-dimensional CAD model of digital geometric co-ordinates, of the casting) based on the example of a gas turbine blade 2 (FIG. 7) comprising inner cooling channels 3, 3′, and specifically including producing a ceramic core 4, 4′ (FIG. 1; also using the 3D model of the casting). The ceramic core 4, 4′ is configured to form the hollow structures 3, 3′.

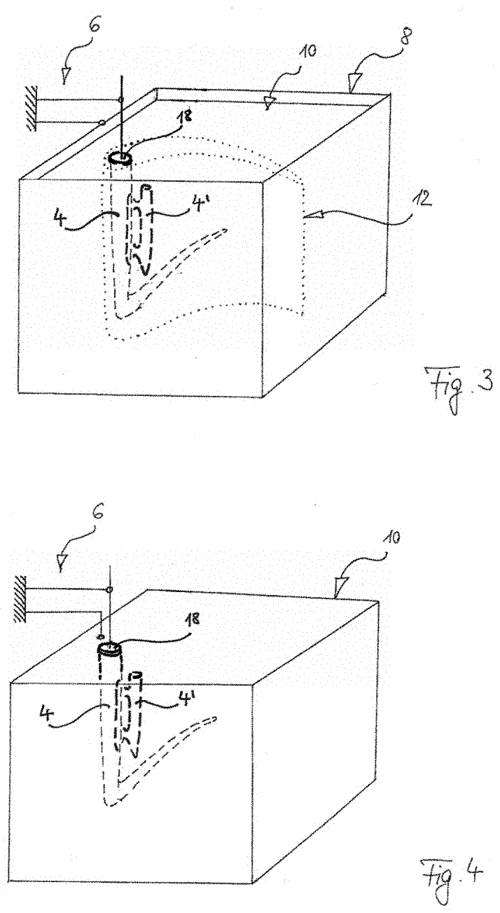

Using a 3D model of a casting 2 (FIG. 7), a core 4, 4′, shown in FIG. 1, is produced according to the 3D model in an initial method stage (see FIG. 8 ff below). According to FIG. 2, in a next method step the core 4, 4′ is positioned in a processing holding device 6. Arranged around the core is a vessel (volume) 8, likewise positioned and secured in the processing holding device 6.

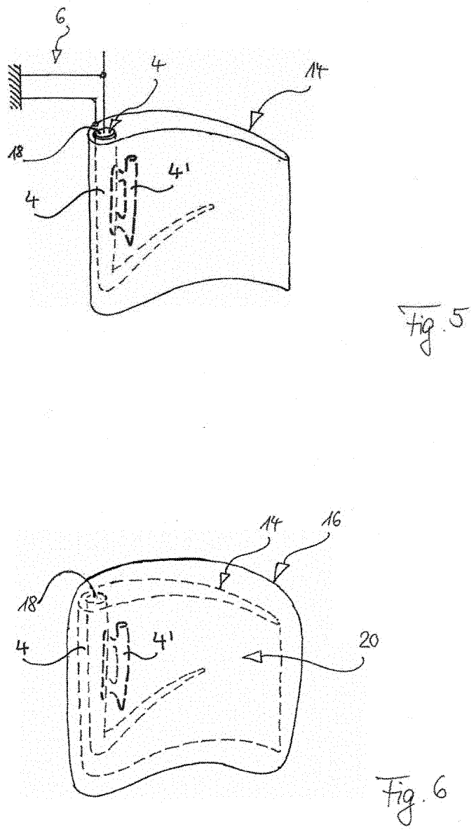

According to FIG. 3, in a next method step model wax 10 is poured into the volume 8 around the core 4. The volume 8 is larger than the cubic dimensions 12 of the casting, and therefore the model wax 10 is poured into the volume 8 and around the core 4 on all sides until it extends beyond the cubic dimensions 12 of the casting. According to the 3D model of the casting 2 (FIG. 7), the spatial position of the cubic dimensions 12 of the casting in the volume 8 is determined by the position of the core 4 in the processing holding device 6. According to FIG. 4, in a next method step the model material 10 is now allowed to solidify around the core 4, and the volume 8 is removed.

According to FIG. 5, in a next method step the outer contour of a temporary (lost) model 14 of the casting 2 (FIG. 7) is produced around the core 4, and specifically from the solidified model material 10 in accordance with the 3D model by CNC milling (not shown).

After this step, the resulting wax model 14, with the core 4 inside it, is removed from the processing holding device 6 (for example by releasing an adhesive connection or by severing ceramic core material at the transition point to the holding device). The processing holding device 6 is no longer present in the further steps. Instead, the wax model 14 with the core 4 is mounted on what is referred to as a “wax cluster” (not shown), which forms the gating system, and fixes the model by mechanical means.

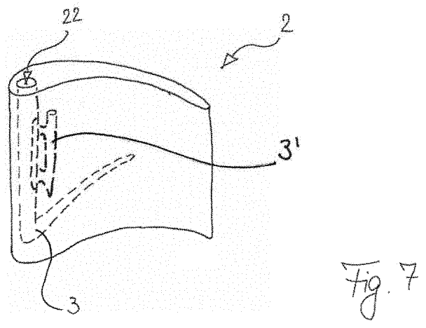

The connection of the core to the ceramic shell 16, now to be produced with reference to FIG. 6, is produced by means of what are referred to as “core locks” 18 or “core marks” 18. These are areas in which the core 4 emerges from the wax model and, during coating with ceramic 16 (now taking place), connects securely to the ceramic shell 16. The positioning between the wax model 14 and the core 4 therefore no longer needs to be provided by the processing holding device 6.

According to FIG. 6, in the next method step, a ceramic mould 16 is therefore applied onto the outer contour of the lost model 14, and in this situation a positioning connection 18 of the ceramic mould 16 is formed by way of a core mark 18 with the core 6, such that the ceramic mould 16 is positioned dimensionally accurately in relation to the core 4 in accordance with the 3D model (not shown) of the casting 2 (FIG. 7) by the core mark 18. The lost model 14 is then removed from the ceramic mould 16 around the core 4 (both of these continue to be held and positioned in relation to one another by the positioning connection 18). A hollow mould 20 is formed between the surface of the ceramic core 4 and the inner surface 14 of the ceramic mould 16. The actual casting mould (to be destroyed after casting, i.e. “lost”) is finished.

Molten metal (not shown) is then poured therein. This is subsequently left to cool. The molten metal (not shown) solidifies to form the solid casting 2, which according to FIG. 7 becomes visible in a next method step (by the removal of the lost ceramic mould 16 and of the ceramic core 4 from the casting 2), and is therefore available as a component with a hollow structure 22 (corresponding precisely to the core 4) with a high degree of dimensional precision.

The method for producing the ceramic core 4, 4′ shown in FIG. 1 serves, so to speak, as a preparation of the actual production—described so far—by means of casting (according to FIGS. 6 and 7) of the casting 2 comprising hollow structures 3, 3′, in that it is an initial method stage for producing the core 4, 4′ as a component of the (lost) mould 16 of the casting 2, which is followed by the subsequent method stages (according to FIGS. 2 to 6) for producing the (lost) mould 16 of the casting 2—and to which, as described, these are geometrically oriented in a highly precise manner.

This particular method for producing the ceramic core 4, 4′ shown in FIG. 1, and also the cores 4, 4′ according to FIG. 8-10, is directed at producing the ceramic core from (at least) two portions 4 and 4′, and comprises the following steps:
a) Producing the first portion 4 of the ceramic core—specifically by means of casting technology—including at least one first joining structure 24 in a surface of the portion;
b) Producing at least one second portion 4′ of the ceramic core—specifically by means of 3D printing technology—including at least one second joining structure 26, matching the first joining structure 24, in a surface of the second portion 4′;
c) Joining the at least one first portion 4 and the at least one second portion 4′ of the core, at matching joining structures 24, 26, to the core, according to geometric co-ordinates of the casting.

In this case, the production by means of casting technology comprises the following steps:
i. Unpressurised or at least low-pressure casting of a ceramic blank of the core portion 4 by means of slip casting, pressure slip casting, cold isostatic pressing, hot isostatic pressing, uniaxial pressing, hot casting, low-pressure injection moulding, gel casting or extrusion, and specifically with an oversize with respect to the geometric co-ordinates of the core;
ii. CNC processing, in particular CNC milling of the core according to the 3D model in a first CNC processing method.

In detail, in this case at least one interface or joining location 28 is defined in the 3D model, up to which the core geometry details are to be produced by casting technology as a one-piece core component region 4 or core base body 4 (as stated in particular by means of a core blank and the subsequent CNC processing thereof). In this way, the overall core 4, 4′ can be assembled at the joining points 28 from at least two core component regions 4, 4′. The core component regions 4, 4′ can all be produced by means of casting technology (for example in order to be able to exceed dimension limits, for instance of the producibility of an overall core formed as one piece). Alternatively at least one core component region 4′ on the other side of the joining point 28 is (as in the examples shown) produced by means of 3D printing technology, in particular in order to be able to produce smaller and more complex details 29 there (the latter for example undercuts, or also more complex cavities of the core (29 in FIG. 8c; i.e. ribs or other solid portions of a more complex shape in the cavity (to be formed later by the core) of the component to be produced), than can be achieved by means of casting techniques. A joined core component region 4′ can for example be placed on a surface of another core component region 4 (for example according to FIG. 8b) or inserted into a penetration (for example according to FIG. 8c), and thus appear on more than one surface of the other core component region 4.

Thus, a first joining structure 24 and a matching second joining structure 26 of the at least one interface or joining location 28 is formed in greater detail in the 3D model, for production, using connection technology, of a mechanically secure bridging of the two core component regions 4 and 4′.

The selection of the core component regions 4′ which are produced as “3D ceramic” by means of 3D printing technology, follows the preferred rule of implementing particularly finely detailed features or particularly small and complex details in 3D printing technology, for example in order to achieve greater design freedom with respect to gap widths, undercuts and the like (which are problematic in particular in CNC milling).

Following preparation of the two joining surfaces 24, 26 or joining structures 24, 26, for example as a clearance fit, with or without a ceramic adhesive, the two core component regions are joined. In this case, preparation steps may be (alternatively or cumulatively): cleaning, drying, deburring, chemical surface treatment, applying adhesive 30.

FIG. 10 schematically shows differently designed joining points 28 of the core component regions 4 and 4′ in a form-fitting connection having a clearance fit in a conical or wedge seat: without adhesive (FIG. 10a); with adhesive 30 (FIG. 10b et seq.), and specifically in a cavity 32 formed in the joining surface 28 (FIG. 10b); with adhesive in pin-shaped chambers 34 which cross the joining surface 28 (FIG. 10c); with spacers 36 which, located in a form-fitting manner in grooves 38, hold the joining contours 24, 26 at a distance for the adhesive 30, which is filled with the adhesive 30 (FIG. 10d). It is also possible for the core component regions 4 and 4′ to be “locked” together in a form-fitting connection, for example by means of a dovetail contour 40 (FIG. 10e), and then possibly also additionally adhesively bonded.

### LIST OF REFERENCE SIGNS

casting 2
gas turbine blade 2
hollow structures 3, 3′
inner cooling channels 3, 3′
ceramic core 4, 4′
processing holding device 6
vessel (volume) 8
model wax 10
model material 10
cubic dimensions 12 of the casting
lost model 14
wax model 14
inner surface 14
portion 4
ceramic shell 16
lost mould 16
core locks 18
core marks 18
connection 18
hollow mould 20
hollow structure 22
joining structure 24, 26
interface or joining location 28
adhesive 30
cavity 32
pin-shaped chambers 34
spacer 36
grooves 38
dovetail contour 40

1. A method for producing a ceramic core for preparing the production of a casting having hollow structures which the ceramic core is configured to form, using a 3D model of digital geometrical co-ordinates of the casting, the method comprising acts of:
a) producing at least one first portion of the ceramic core using casting technology, the first portion including at least one first joining structure in a surface of the first portion;
b) producing at least one second portion of the ceramic core using casting technology or 3D printing technology, the second portion including at least one second joining structure, which matches the first joining structure, in a surface of the second portion, wherein producing the at least one second portion using casting technology in act b) comprises acts of:
i. unpressurized or low-pressure casting of a ceramic core blank with an oversize relative to the core according to the geometric co-ordinates; and
ii. CNC processing of the core, according to the 3D model, in a first CNC processing method; and
c) joining the at least one first portion and the at least one second portion of the core at the matching first and second joining structures to form the core according to geometric co-ordinates of the casting.

2. A ceramic core for producing a casting having hollow structures which the ceramic core is configured to form, using a 3D model of digital geometrical co-ordinates of the casting, using a ceramic mould, wherein the core is produced by acts of:
a) producing at least one first portion of the ceramic core using casting technology, the first portion including at least one first joining structure in a surface of the first portion;
b) producing at least one second portion of the ceramic core using casting technology or 3D printing, the second portion including at least one second joining structure, which matches the first joining structure, in a surface of the second portion, wherein producing the at least one second portion using casting technology in act b) comprises acts of:
i. unpressurized or low-pressure casting of a ceramic core blank with an oversize relative to the core according to the geometric co-ordinates; and
ii. CNC processing of the core, according to the 3D model, in a first CNC processing method; and
c) joining the at least one first portion and the at least one second portion of the core at the matching first and second joining structures to form the core according to geometric co-ordinates of the casting.

3. The method according to claim 1, wherein act a) further comprises acts of:
i. unpressurized or low-pressure casting of a ceramic core blank with an oversize relative to the core according to the geometric co-ordinates; and
ii. CNC processing of the core, according to the 3D model, in a first CNC processing method.

4. The method according to claim 1, wherein act i) is performed using slip casting, pressure slip casting, cold isostatic pressing, hot isostatic pressing, uniaxial pressing, hot casting, low-pressure injection moulding, gel casting or extrusion.

5. The method according to claim 1, wherein act ii) includes CNC milling.

6. The method according to claim 1, further comprising acts of:
d) positioning the core in a processing holding device;
e) pouring model material around the core, into a volume greater than the cubic dimensions of the casting, which, according to the 3D model, is spatially determined by the position of the core in the processing holding device, and allowing the model material to solidify;
f) CNC production of an outer contour of a lost model of the casting from the solidified model material around the core, in accordance with the 3D model in a second CNC production method;
g) applying a ceramic mould onto the outer contour of the lost model and forming a positioning connection of the ceramic mould with the core;
h) removing the lost model from the ceramic mould around the core;
i) pouring metal into the ceramic mould around the core;
j) solidifying of the molten metal to form the solid casting and cooling channels; and
k) removing the ceramic mould and the core from the casting.

7. The ceramic core according to claim 2, wherein act a) further comprises acts of:
i. unpressurized or low-pressure casting of a ceramic core blank with an oversize relative to the core according to the geometric co-ordinates; and
ii. CNC processing of the core, according to the 3D model, in a first CNC processing method.

8. The ceramic core according to claim 2 wherein act i) is performed using slip casting, pressure slip casting, cold isostatic pressing, hot isostatic pressing, uniaxial pressing, hot casting, low-pressure injection moulding, gel casting or extrusion.

9. The ceramic core according to claim 2, wherein act ii) includes CNC milling.
